(19) United States
(12) Patent Application Publication
(10) Pub. No.: US 2025/0075116 A1
(43) Pub. Date: Mar. 6, 2025

(54) Nano-Modified Polymer Injectate for Improving Energy Sweep in Geothermal Reservoirs and Methods of Making

(71) Applicant: UNM Rainforest Innovations, Albuquerque, NM (US)

(72) Inventors: John C. Stormont, Albuquerque, NM (US); Mahmoud Reda Taha, Albuquerque, NM (US); Usama Farid Kandil, Nasr City, (EG); Daniel Heras Murcia, Albuquerque, NM (US)

(73) Assignee: UNM Rainforest Innovations, Albuquerque, NM (US)

(21) Appl. No.: 18/951,557

(22) Filed: Nov. 18, 2024

Related U.S. Application Data
(63) Continuation-in-part of application No. 18/152,714, filed on Jan. 10, 2023, now abandoned.
(60) Provisional application No. 63/297,990, filed on Jan. 10, 2022.

(51) Int. Cl. C09K 8/508; C09K 8/516; C09K 8/84

(52) U.S. Cl. CPC C09K 8/5086; C09K 8/516; C09K 8/845; C09K 2208/10; C09K 2208/26

(57) ABSTRACT

The present invention provides a device, system, and method for eliminating short-circuiting and improving energy sweep in geothermal reservoirs.

### RELATED APPLICATIONS

This application is a continuation-in-part of U.S. Ser. No. 18/152,714 filed on Jan. 10, 2023, which claims priority to U.S. Provisional Application No. 63/297,990, filed on Jan. 10, 2022, which is incorporated in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

In geothermal wells, energy is extracted by circulating water through a network of connected fractures. Short-circuiting, a term used to express a noticeable reduction in energy extraction efficiency in a geothermal reservoir, is a significant challenge in geothermal wells that typically occur due to increased fracture opening size. Such an increase results in these fractures conducting more flow through them than intended, which reduces the amount of thermal energy extracted from the rock formation. Highly conductive fractures negatively impact the reservoir sweep efficiency. There is a significant need for a method to stop/or reduce the short-circuiting and improve energy sweep in geothermal reservoirs.

### BRIEF SUMMARY OF THE INVENTION

In one embodiment, the present invention provides a device, system, and method for eliminating short-circuiting and improving energy sweep in geothermal reservoirs.

In another embodiment, the present invention provides a device, system, and method for selectively modifying fractures in the fracture network in geothermal reservoirs to improve energy sweep.

In another embodiment, the present invention provides a device, system, and method that controls the permeability of fracture networks in geothermal reservoirs, thus eliminating short-circuiting.

In another embodiment, the present invention provides a device, system, and method that bonds an active porous multi-layered polymer network inside subsurface fractures to reduce permeability and improve energy sweep.

In another embodiment, the present invention provides a device, system, and method for controlling the polymerization process to produce a porous polymer network and enabling its formation in multi-layers adhered to the rock formation.

In another embodiment, the present invention provides a device, system, and method for delivering polymer injectate to the fracture surface to improve energy sweep efficiency.

In another embodiment, the present invention provides a device, system, and method that provides a nano-modified polymer/monomer with very high wettability to penetrate fracture surfaces in the rock formation, push water out of those spaces, bond to fracture surfaces in the rock formation, and polymerize to form a porous polymer network with controlled porosity and permeability.

In another embodiment, the present invention provides a device, system, and method for producing a flexible multi-layer porous polymer with enhanced mechanical properties, high fatigue strength, superior bonding between layers, and excellent bonding with fracture surfaces in rock formations.

In another embodiment, the present invention provides a device, system, and method that provide high-pressure spherical microcapsules incorporating expansive materials triggered by the temperature inside the fracture to expand and reduce the permeability inside the fracture.

In another embodiment, the present invention provides nano-modified multiphene polymer injectates wherein the nano-modified multiphene polymer references to specifically structured multi-phenolic mix blended with COOH-Silane functionalized multi-walled carbon nanotubes (MWCNTs), graphene nanoparticles (GNPs), alumina (Aluminum oxide) nanoparticles and silica (Silicon oxide) nanoparticles using aprotic high-temperature solvents.

In another embodiment of the present invention, the content of the nanoparticles for nanomodification is determined to meet the specific rheological, mechanical, and thermal characteristics of the polymer injectate.

In another embodiment, the nano-modified multiphene polymer injectate of the present invention has an adjustable initial viscosity ranging from 50 to 1000 cps at ambient temperature (e.g., 22° C.) and up to 200-1000 cPs after 2 hours of mixing.

In another embodiment, the nano-modified multiphene polymer injectate of the present invention has a gelation time of 120-480 minutes based on the injectate volume and excellent thermal stability up to 475° C.

In another embodiment, the nano-modified multiphene polymer injectate of the present invention is wettable to granite, limestone, sandstone, and other rock formations, able to displace water, and hardens with minimal volume shrinkage.

In another embodiment, the nano-modified multiphene polymer injectate of the present invention provides an alternative for a polymer injectate in geothermal wells.

In another embodiment, the present invention provides nano-modified multiphene polymer injectate delivered by thermally degradable microcapsules to modify fracture permeability in geothermal wells.

In another embodiment, the present invention provides nano-modified multiphene polymer injectate fabricated using dimethacrylate derived composite microcapsules that rupture after 15 minutes at 320° C., demonstrating cargo release as a function of time at geothermal-relevant temperatures.

Additional objects and advantages of the invention will be outlined in the following description and, in part, will be evident from the description or may be learned by practice of the invention. The objects and advantages of the invention will be realized and attained through the elements and combinations pointed out in the appended claims.

It is to be understood that both the general and detailed descriptions are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals, they may describe substantially similar components throughout the several views. For example, numerals with different letter suffixes may represent different instances of substantially similar components. The drawings illustrate generally, by way of example, but not by limitation, a detailed description of specific embodiments discussed in the present document.

FIG. 1 shows an embodiment of the present invention, showing how a nano-modified polymer injectate allows the sequential building of multiple layers of porous polymer adhered to each other and fracture surfaces.

FIG. 2 illustrates an embodiment of the present invention, showing how porous polymers can be developed in large fracture networks in the subsurface rock formations by injecting an engineered mix of a polymerizable monomer with a low molar mass preferred organic solvent, which is initially miscible with the monomer and separates upon polymerization.

FIG. 3 illustrates another embodiment of the present invention, showing how a fluorinated nano-modified polymer resin may be used as a base material to coat the open fracture surface, penetrate the rock formation, and form a porous polymer network that is firmly adhered to the fracture surface.

FIG. 4 schematic illustration (left) and microscopy image (right) of capillary microfluidic device fabricating double emulsion microcapsule templates.

FIG. 5 shows an optical (left, middle) and SEM (right) acrylic microcapsule images wherein the shell thicknesses can range from hundreds of nanometers (left, right) to microns (middle) with scale bars=500 microns.

FIG. 6 provides TGA signature curves for acrylate (left) and dimethacrylate (right) derived composite microcapsules.

FIG. 7 provides time series microscopy images of acrylic microcapsules in silicone oil carrier fluid incubated at 320° C. At the 15-minute mark,>80% of the capsules ruptured.

FIG. 8A shows particle trajectories for typically dilated fracture, revealing parallel flow paths over the entire fracture surface wherein the flow direction is from the bottom to the top of the figure, and the white dots are microcapsules moving in well-connected flow paths.

FIG. 8B shows particle trajectories for sheared fracture displaying tortuous flow concentrated in channels and exclusion from smaller and not well-connected portions of the fracture wherein the flow direction is from the bottom to the top of the figure, and the white dots are microcapsules moving in well-connected flow paths.

FIG. 9 provides the hydraulic aperture to microcapsule diameter for complete blockage (exclusion) and unobstructed flow for three fractures of different roughness that have been sheared and/or dilated different amounts. Fracture C is the smoothest, followed by fracture A, and fracture D is the roughest.

### DETAILED DESCRIPTION OF THE INVENTION

Detailed embodiments of the present invention are disclosed herein; however, it is understood that they are merely exemplary of the invention, which may be embodied in various forms. Therefore, specific structural and functional details disclosed herein are not to be interpreted as limiting but merely as a representative basis for teaching one skilled in the art to variously employ the present invention in virtually any appropriately detailed method, structure, or system. Further, the terms and phrases used herein are not intended to be limiting but to provide an understandable description of the invention. In one embodiment, the present invention provides a method, device, and system to eliminate short-circuiting, reduce the effective permeability of the fracture network, and improve the energy sweep in geothermal reservoirs. The embodiments of the present invention minimize flow in larger fractures.

In a preferred embodiment, the present invention concerns a nano-modified polymer injectate with a specific viscosity that incorporates microparticles to prevent ingress into a small fracture network. The nano-modified polymer injectate is used to fill the fracture opening, thus limiting water flow to eliminate short-circuiting in geothermal reservoirs and improve energy sweep efficiency. The nano-modified polymer injectate creates a multi-layer porous polymer network inside the large fractures, reducing permeability and improving energy sweep.

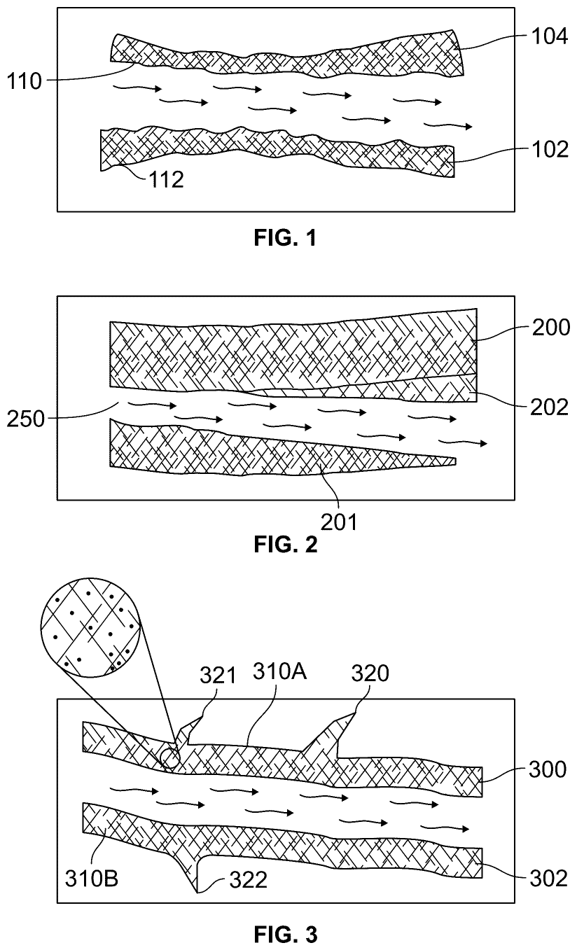

As shown in FIG. 1, in one embodiment, the nano-modified polymer injectate allows the sequential building of multiple porous polymer layers 102 and 104 adhered to each other and fracture surfaces 110 and 112. Adjusting the mobility ratio of the nano-modified polymer injectate to water (or the geothermal energy reservoir water-formation liquid) controls the ability to flow the new nano-modified polymer injectate inside cracks in fractures surfaces 110 and 112 of rock formations. The nano-modified polymer injectate is designed to push the water out of the fracture opening, occupy that space, and harden to form a porous polymer network adhering to the fracture surface.

In other embodiments, as shown in FIG. 2, porous polymers can be developed in large fracture networks in the subsurface rock formations by injecting an engineered mix of a polymerizable monomer with a low molar mass preferred organic solvent, which is initially miscible with the monomer and separates upon polymerization. Polymerization of the above mix at high temperatures will form a porous polymer network due to the evaporation of the solvent. This allows a user to partially fill the fracture and thus not wholly block flow in the fracture. The amount of flow blockage in the fracture can be adjusted by increasing or decreasing the amount of solvent, which controls the porosity of the porous polymer. After injection, latent hardeners may also be used to control polymerization at the desired temperature in the rock fracture.

As shown in FIG. 2, the polymer layers may be added sequentially by first forming layers 200 and 201 and then later adding layer 202. Fluid flow inside fracture 250 may be controlled and optimized by varying the thickness of layers 200-202 as well as the location and the number of layers used and the resulting porosity of these layers

In other embodiments, the present invention formulates a highly thermally stable polymer network using a microencapsulated anionic catalyst (a Lewis base such as tertiary amines or imidazoles) or a cationic catalyst (a Lewis acid such as a boron trifluoride complex) to enable catalytic homopolymerization, where the polymer reacts with itself and polymerizes under temperature stimulation. The materials and method allow the chemical bonding of the different porous polymer layers via reactive chemical groups through several injections of the nano-modified polymer injectate.

Enabling a multi-layer bond-active porous polymer network can be achieved by controlling the polymerization process, engineering the amount of hardener, using latent hardeners, and creating a mix of polymerized and non-polymerized polymer. The materials and methods of the present invention ensure that the multi-layer porous polymer network, injected at different times, adheres together and to the fracture surface in the rock formation, thus filling all or a portion of the fracture opening to a sufficient extent necessary to reduce permeability, eliminate or reduce short-circuiting, and improve energy sweep.

The degree of porosity, connectivity, and permeability of the present invention's multi-layer porous polymer network is designed to meet the fracture's desired water permeability. If a multi-layer porous polymer does not seal the fracture to the desired degree, an additional polymer injectate can be applied to reduce polymer porosity. Controlling the starting mixing ratio of the engineered polymer mixture creates a removable or dissolved multi-layer porous polymer that can be reversed to reverse the process.

In another embodiment, as shown in FIG. 3, the present invention provides a silaneated-fluorinated-nano modified polymer resin which may be used as base material 300 and 302 to coat open fracture surface 310A and 310B, penetrate the rock formation including rock cracks 320-322, and form a porous polymer network which is firmly adhered to the fracture surface. Potential polymers that may be used as the base material for the porous polymer include but are not limited to Epoxy resins (Novolac Epoxy, Amine Epoxy, etc.), Esters, Altium, PEEK, and other high-temperature polymers. Fluorinated polymers are suggested for their low surface tension, acting as a wetting agent that penetrates and bonds to fracture surfaces in rock formations. Silaneated polymers allow the development of high bond strength to most of the rock formation surfaces. Alumina nanoparticles (as an additive with an amphoteric nature) may also be used to control the polymerization process and improve the bond of the porous polymer network to the rock formation. Alumina nanoparticles also will improve polymer flexibility and fatigue resistance for thermal stress cycles. Other nanoparticles incorporating carbon nanotubes, carbon nanofibers, ferrite nanoparticles, etc., may also be used to improve the physical and mechanical characteristics of the multi-layer porous polymer network.

The thermal conductivity of the porous polymer network is controlled by selecting the nano-filler, “e.g., nano-silica,” to achieve the desired thermal conductivity.

The nano-modified polymer injectate of the present invention should be well-suited for use in a wide range of rock formations typically containing geothermal energy reservoirs (e.g., granite, limestone, sandstone, feldspar, etc.).

In other aspects, the present invention concerns the inclusion of nano and micro particulates with specific sizes and surface functionalization to alter the polymer viscosity and mobility ratio to prevent the polymer from entering fractures below a particular size.

In other aspects, the present invention concerns nanoparticles (e.g., functionalized nano-silica) used to improve the bond between the multi-layer porous polymer network and the fracture surfaces in the rock formation.

In other aspects, the present invention concerns the injection of surface-activated microparticles that bond to the porous polymer network, enabling an alternative method to reduce the multi-layer porous polymer network porosity and the partially filled crack permeability.

The present invention concerns industrial-grade, nitrogen-treated, and/or nano-modified polymer injectate incorporating carbon nanotubes, carbon nanofibers, alumina nanoparticles, zinc nanoparticles, silica nanoparticles, and other nanoparticles.

In other aspects, the present invention concerns a delivery method that depends on the size of the fracture to be modified and the presence of adjacent fractures. The polymerization process is engineered to consider viscosity, mixing ratio, and mobility ratio to control fracture size in large and small fractures.

In other aspects, the present invention for large fractures concerns reactants that can be delivered in microcapsules that are small enough to enter the targeted fracture but not so small as to enter and plug adjacent, small fractures. Microcapsule technology allows injectate reactivity conditions to be controlled by designing the microcapsules to rupture at the desired temperature and stress conditions.

In other aspects, the present invention concerns high-pressure microcapsules included in the polymer injectate. The microcapsules use high-strength and ductile polymer membranes to prevent rupture under high pore pressure. The microcapsule surface is functionalized to bond to the porous polymers and/or the rock formation. The microcapsules incorporate reactive expansive constituents. The high temperature inside the targeted fracture triggers the expansive reaction. The expansion is significant enough to lock the microcapsules inside the fracture. The enlarged microcapsules will allow water to flow through the pores between them but will reduce the permeability inside the fracture.

In yet another embodiment, the present invention provides a method for modifying the permeability of fractures in a fracture network in geothermal reservoirs to improve energy sweep. The method includes introducing an injectate into the fracture network. The injectate may comprise compositions disclosed above, such as a resin base, hardener, and nanoparticles. Once the resin and hardener react, the resulting polymer displaces water and bonds to fractures within the network.

A solvent may be added before polymerization to render the resulting polymer porous. The solvent's evaporation creates a porous polymer, and the amount and type of solvent may modify its porosity.

To avoid filling or modifying desired cracks within a fracture network, such as those within a desired size range, the microcapsules may be sized to target specific crack sizes outside of the desired range. For example, to only affect cracks of a predetermined minimum size or larger, the microcapsules are sized only to enter and move within a predetermined crack size.

In other applications, microcapsules contain various cargo, such as solvents, nanoparticles, hardeners, and other materials.

The injection pressure used may vary to steer or direct the injectate to certain locations within a fracture network. Another technique is to vary the injectate's flow rate. Alternately, the injection pressure and flow rate may vary as desired.

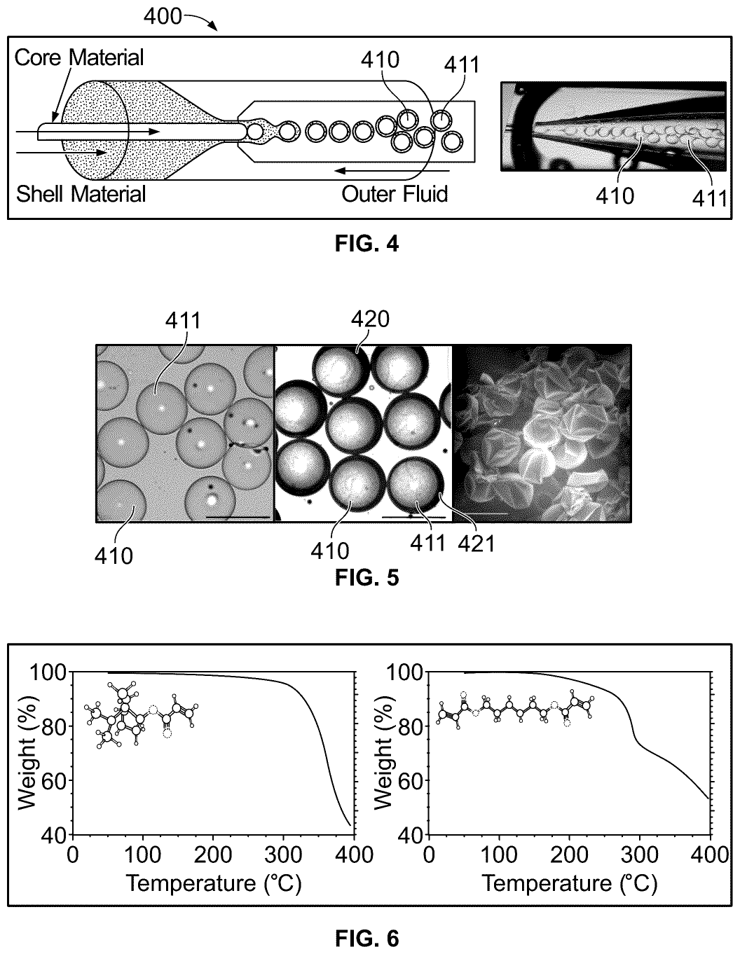

In another embodiment of the present invention, thermally stable polymeric shell microcapsules (MCs) containing aqueous or organic cargo were fabricated using double emulsion templates. As shown in FIGS. 4 and 5, droplet microfluidic devices 400 may be used to fabricate double emulsion templates 410-411 with liquid monomeric shell material for chemically diverse acrylic microcapsules with well-defined and monodisperse diameters ranging from 100-500 microns and tunable shell thickness 420-421 ranging from hundreds of nanometers to microns. The resulting templates 410-411 provide thermal stability and tunable shell thermal decomposition temperatures and kinetics.

Acrylic microcapsules are formed by UV-induced radical polymerization of acrylate-based monomers to produce thermosetting polymer shells. This allows for the selection of diverse shell material monomers to tune capsule (i) thermal stability at temperatures up to 250° C. and (ii) associated thermal decomposition-induced release profiles.

This tunable thermal decomposition behavior of the embodiments of the present invention is shown in FIG. 6 where TGA analysis of microcapsules with two different acrylic shells fabricated from acrylate or dimethacrylate monomer composites, respectively, shows resulting distinct thermal decomposition for the two monomers, ranging from around 250 to >300° C.

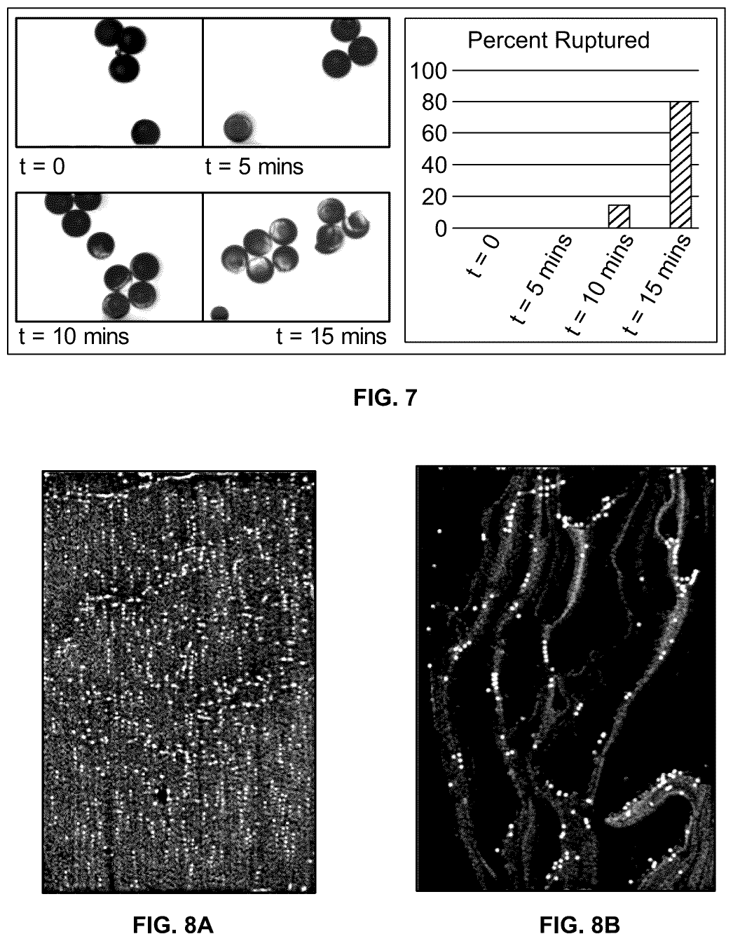

As shown in FIG. 7, the dimethacrylate-derived composite microcapsules of the present invention rupture after 15 minutes at 320° C. under atmospheric pressure. The time path of rupturing for acrylic microcapsules was assessed by microscopy by imaging capsules with an air core collected from a 320° C. heated sample (high-temperature silicone oil as a carrier fluid) at 5, 10, and 15 minutes. The aqueous core was replaced with air by evaporation because the capsules would undergo ‘steam explosions’ when exposed to temperatures above 100° C. at atmospheric pressure. Results are shown in FIG. 7, which reveals that the thermal decomposition of the capsule shells results in the rupture of >80% of the capsules at the 15-minute time mark.

Deployment and transport of microcapsules in rough fractures.

Understanding how microcapsules move into and through rough fractures is important to deploying the embodiments of the present invention. Microcapsules should be excluded (blocked) from smaller fractures that are not meant to be modified with the polymer.

A flow visualization system has been developed to visualize microcapsule movement in rough fractures. This system has been used to measure microcapsule entry, transport, and blocking within fractures to provide data for developing blocking functions for sheared and dilated fractures. The system involves establishing steady flow through a transparent fracture replica, introducing microcapsules into the flow stream, video recording the microcapsule movement, and applying particle tracking software.

Transparent fracture replicas were created from fractured granite specimens. Fracture topography data was obtained by profiling the fracture surface. The fracture replicas were integrated into a flow cell, allowing the fractures to be sheared and dilated to create a fracture network. Fluorescent 1 mm diameter microcapsules were passed through the fractures. Filming determines the microcapsules' location and amount of blockage (retention) in the fractures at different amounts of shear and dilation. In addition, a direct method to measure the aperture field of the fracture network was developed using a light transmission technique in which the light intensity through the fracture replica was measured with water and with a dye to interpret the fracture aperture field via the Beer-Lambert Law. These results reveal that shear displacement creates complicated fracture networks that vary significantly with the amount of shear, consistent with the findings of others.

Particle trajectories within a fracture during flow are shown in FIGS. 8A and 8B for two conditions for the same fracture: normal displacement and shear displacement. When the fracture is normally displaced, once the displacement allows microcapsules to enter, the flow of microcapsules is relatively uniform in the direction of the hydraulic gradient. In contrast, when this fracture is sheared, the flow of microcapsules is concentrated into channels and moves around locations of small aperture or where microcapsules become blocked.

Tests were conducted on three fractures with varying degrees of roughness: fracture C was the smoothest, fracture A was of intermediate roughness, and fracture D was the roughest. The blocking results relate to the fracture's hydraulic aperture. The hydraulic aperture is the aperture of a smooth-walled parallel fracture that produces the same amount of flow as the rough-walled fracture and can be related directly to the fracture permeability.

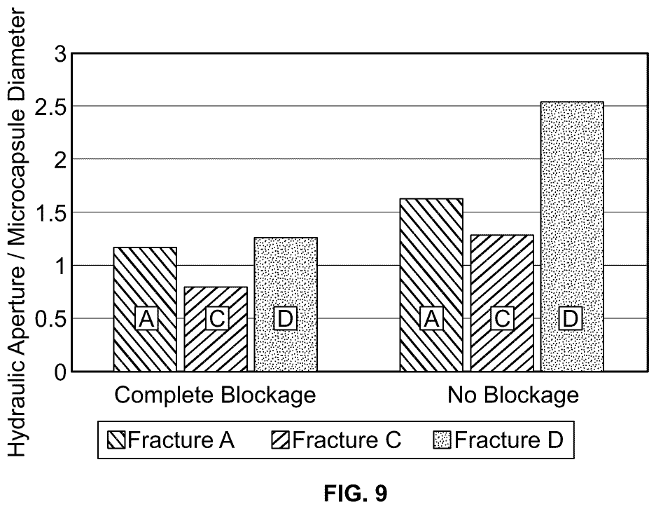

The ratio of hydraulic aperture to microcapsule diameter for complete blockage and no blockage is given in FIG. 9. No blockage is the desired condition for fractures that may be modified: microcapsules can pass into this region, then they thermally degrade, and the porous polymer will polymerize. Complete blockage, including excluding microcapsules from the fracture, is suitable for fractures not to be modified, i.e., they are not preferential flow paths that lead to thermal short-circuiting. The results shown in FIG. 9 reveal that the hydraulic aperture for no blockage and complete blockage are different for different fractures. The rougher the fracture, the greater the hydraulic apertures are for these conditions.

The disclosure should, therefore, not be limited by the above-described embodiments, methods, and examples but by all embodiments and methods within the scope and spirit of the disclosure.

What is claimed is:

1. A method to modify the permeability of fractures in a fracture network in geothermal reservoirs to improve energy sweep comprising the steps: introducing an injectate into the fracture network; said injectate comprising a resin base, hardener, and nanoparticles; once said resin and hardener react, the resulting polymer displaces water and bonds to the fractures.

2. The method of claim 1 further including the steps of introducing a solvent to said injectate and evaporating said solvent, said evaporation of said solvent renders said polymer porous.

3. The method of claim 1, wherein said hardener is encapsulated in microcapsules, said microcapsules are adapted to degrade as a function of temperature and thereby release said hardener in a controlled manner.

4. The method of claim 3 wherein said microcapsules are sized to enter and move within a predetermined crack size.

5. The method of claim 3 wherein said microcapsules contain solvent and nanoparticles.

6. The method of claim 3 wherein said microcapsules contain said solvent.

7. The method of claim 3 wherein said microcapsules contain said nanoparticles.

8. The method of claim 1 wherein a plurality of said injectate is introduced.

9. The method of claim 1 wherein said injectate is directed to a predetermined location by varying the injection pressure and flow rate.

10. The method of claim 1 wherein said injectate is removed with an acid.

11. The method of claim 1 wherein said porosity of the resulting polymer is modified by the amount and type of solvent.

12. The method of claim 1 wherein said resin is a silaneated-fluorinated nano-modified polymer resin.

13. A method to modify the permeability of fractures in a fracture network in geothermal reservoirs to improve energy sweep comprising the steps: introducing a nano-modified multiphene polymer injectate into the fracture network; said injectate comprising structured multi-phenolic mix blended with COOH-Silane functionalized multi-walled carbon nanotubes (MWCNTs), graphene nanoparticles (GNPs), alumina (Aluminum oxide) nanoparticles and silica (Silicon oxide) nanoparticles using aprotic solvents; once said resin and hardener react, the resulting polymer displaces water and bonds to the fractures.

14. The method of claim 13 wherein said nano-modified multiphene polymer injectate has an adjustable initial viscosity ranging from 50 to 1000 cps at C at ambient temperature (e.g., 22° C.) and up to 200-1000 cPs after 2 hours of mixing.

15. The method of claim 13 wherein said nano-modified multiphene polymer injectate has a gelation time of 120-480 minutes based on the injectate volume and excellent thermal stability up to 475° C.

16. The method of claim 13, wherein said nano-modified multiphene polymer injectate is wettable to granite, limestone, sandstone, and other rock formations, is able to displace water, and hardens with limited volume shrinkage.

17. The method of claim 13 wherein said nano-modified multiphene polymer injectate is fabricated using dimethacrylate derived composite microcapsules that rupture after 15 minutes at 320° C.
